(19) United States
(12) Patent Application Publication
(10) Pub. No.: US 2016/0259765 A1
(43) Pub. Date: Sep. 8, 2016

(54) DOCUMENT INTERACTION EVALUATOR BASED ON AN ONTOLOGY

(71) Applicants: Daqi LI, Xi'an, Shaanxi (CN); Jun FANG, Xi'an, Shaanxi (CN); EMPIRE TECHNOLOGY DEVELOPMENT LLC, Wilmington, DE (US)

(72) Inventors: DAQI LI, XI'AN (CN); JUN FANG, XI'AN (CN)

(21) Appl. No.: 14/435,388

(22) PCT Filed: May 4, 2014
(86) PCT No.: PCT/CN2014/076739

§ 371 Date: Apr. 13, 2015

(51) Int. Cl. G06F 17/22; G06F 3/01

(52) U.S. Cl. CPC G06F 17/2288; G06F 3/013

(57) ABSTRACT

Technologies are generally described for methods and systems effective to evaluate an interaction with a document. In some examples, a method may include identifying, by a processor, content data of the document. The processor may also map the content data of the document to an ontology to identify difference data. The difference data may reflect a difference between the content data and the ontology. The processor may also generate activity data, which may be effective to indicate the interaction with the document. The processor may also compare the activity data with the difference data. The processor may also determine a deviation based on the comparison of the difference data and the activity data. The processor may also evaluate the interaction with use of the deviation.

### BACKGROUND

Unless otherwise indicated herein, the materials described in this section are not prior art to the claims in this application and are not admitted to be prior art by inclusion in this section.

A user may interact with a document such as by reading the document. The document may be displayed on a display, such as a display of a computer. The user may read the document carelessly, which may result in neglect of important contents of the document.

### SUMMARY

In some examples, methods effective to evaluate an interaction with a document are generally described. The methods may include identifying, by a processor, content data of the document. The methods may also include mapping, by the processor, the content data of the document to an ontology to identify difference data. The difference data may reflect a difference between the content data and the ontology. The methods may also include generating, by the processor, activity data, which may be effective to indicate the interaction with the document. The methods may also include comparing, by the processor, the activity data with the difference data. The methods may also include determining, by the processor, a deviation based on the comparison of the difference data and the activity data. The methods may also include evaluating, by the processor, the interaction with use of the deviation.

In some examples, systems configured to evaluate an interaction associated with a document are generally described. The systems may include a memory. The memory may be configured to store content data of the document. The memory may also be configured to store an ontology. The systems may also include a processor. The processor may be configured to be in communication with the memory. The processor may be configured to identify the content data of the document in the memory. The processor may also be configured to map the content data of the document to an ontology to identify difference data. The difference data may reflect a difference between the content data and the ontology. The processor may also be configured to store the difference data in the memory. The processor may also be configured to generate activity data effective to indicate the interaction with the document. The processor may also be configured to store the activity data in the memory. The processor may also be configured to compare the activity data with the difference data. The processor may also be configured to determine a deviation based on the comparison of the difference data and the activity data. The processor may also be configured to evaluate the interaction with use of the deviation.

In some examples, methods effective to generate an ontology associated with a user are generally described. The methods may include receiving, by a processor, event data associated with an event experienced by the user. The methods may also include determining, by the processor, an event rating of the event using the event data. The methods may also include comparing, by the processor, the event rating to a threshold. The methods may also include identifying, by the processor, a concept associated with the event based on the comparison. The methods may also include generating, by the processor, the ontology using the concept.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an example system that can be utilized to implement a document interaction evaluator based on an ontology;

FIG. 2 illustrates the example system of FIG. 1 with additional detail relating to generation of the ontology;

FIG. 3 illustrates the example system of FIG. 1 with additional detail relating to mapping content data of a document to the ontology;

FIG. 4 illustrates the example system of FIG. 1 with additional detail relating to evaluation of an interaction with a document;

FIG. 5 illustrates a flow diagram for an example process for implementing a document interaction evaluator based on an ontology;

FIG. 6 illustrates an example computer program product that can be utilized to implement a document interaction evaluator based on an ontology; and

FIG. 7 is a block diagram illustrating an example computing device that is arranged to implement a document interaction evaluator based on an ontology;

all arranged according to at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices, and computer program products related to a document interaction evaluator based on an ontology.

Briefly stated, technologies are generally described for methods and systems effective to evaluate an interaction with a document. An example interaction with a document may be a user reading an electronic book being displayed on a display of a device. The methods may include identifying, by a processor, content data of the document. For example, the processor may identify data relating to a particular portion, such as a page, of the electronic book. The processor may also map the content data of the document to an ontology to identify difference data. The ontology may be associated with knowledge of the user and may be generated by the processor. In some examples, the ontology may include concepts which are known by the user. The difference data may reflect a difference between the content data and the ontology. For example, the difference data may reflect a difference between a concept's first proficiency level indicated by the content data and the concept's second proficiency level indicated by the ontology. The processor may also generate activity data, which may be effective to indicate the interaction with the document. For example, the activity data may reflect a progress of the interaction being performed by the user, such as a document being read by the user. The processor may also compare the activity data with the difference data. The processor may also determine a deviation, which may be a difference between the difference data and the activity data (described below), based on the comparison of the difference data and the activity data. The processor may also evaluate the interaction with use of the deviation. For example, the processor may compare the deviation with a threshold and in response to the deviation being greater than the threshold, the processor may output an alert to warn the user.

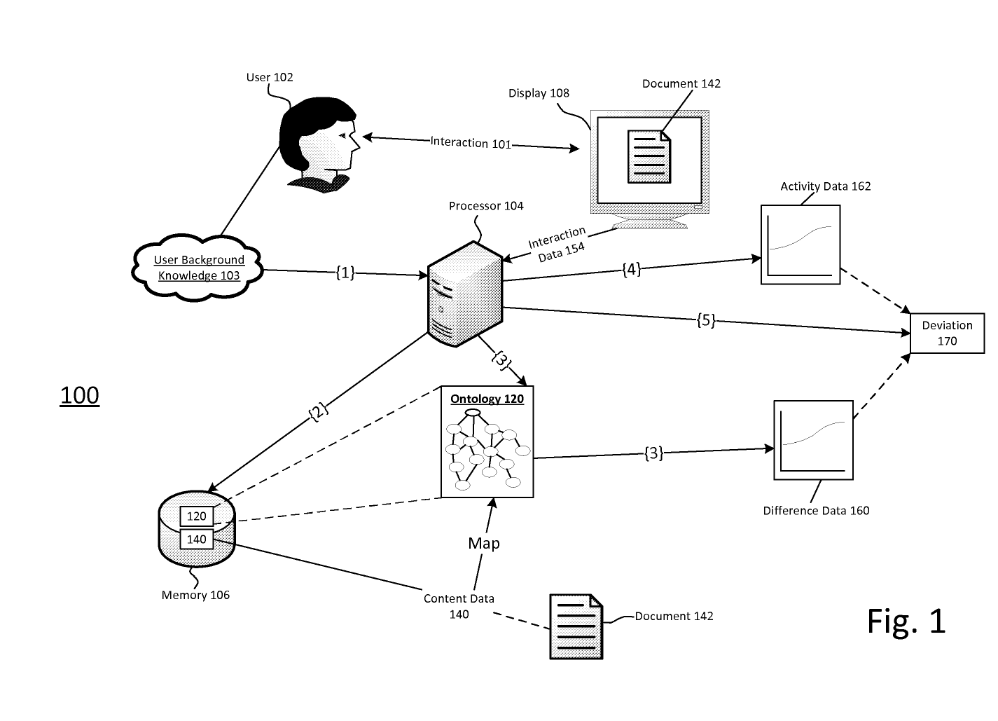

FIG. 1 illustrates an example system 100 that can be utilized to implement a document interaction evaluator based on an ontology, arranged in accordance with at least some embodiments described herein. In summary, system 100 may be implemented to evaluate an interaction 101 which may be an interaction between a user 102 and document 142 displayed on a display 108. Interaction 101 may be a reading activity. As will be described in more detail below, implementation of system 100 may include generation of ontology 120, difference data 160, and/or activity data 162, which may be used for the evaluation of interaction 101. System 100 may include a processor 104, a memory 106, and/or display 108.

Processor 104 may be configured to be in communication with memory 106 and/or display 108. Display 108 may be configured to display a document, such as an image, a video, etc. Processor 104 may be configured to output document 142 to be displayed on display 108. Document 142 may be associated with content data 140 that may include object data associated with objects, such as a number, a letter, or a word, in document 142. Document 142 may be an article, an electronic book, a contract, etc. and content data 140 may be the data associated with the words in the article. Memory 106 may be configured to store content data 140 and may be further configured to store an ontology 120 which, as is described in more detail below, may be a data structure effective to represent concepts and effective to indicate relationships among the represented concepts. Ontology 120 may be processed, such as by processor 104, to produce a graphical representation such as a table, graph, etc. In some examples, processor 104 may be configured to collect data to generate ontology 120. In some examples, a device outside of (e.g., external to or other than) processor 104 may provide data to processor 104 in order for processor 104 to generate ontology 120. In some examples, ontology 120 may be generated by a device outside of processor 104 and may be stored in a memory outside of system 100.

In an example, processor 104 may obtain user background knowledge 103 from user 102 (depicted as operation {1}). User background knowledge 103 of user 102 may be data associated with a background of user 102 such as an educational background, hobbies, and/or work experience, etc. In some examples, processor 104 may obtain user background knowledge 103 from inputs from user 102. For example, user 102 may input information relating to the educational background, hobbies, or work experience, of user 102 in a social networking website. In some examples, processor 104 may obtain user background knowledge 103 from a device, which may be outside of processor 104, configured to obtain user background knowledge 103 from user 102. In some examples, processor 104 may obtain user background knowledge 103 by detecting events relating to user 102 (described below).

In response to obtaining user background knowledge 103, processor 104 may generate and/or update ontology 120 (depicted as operation {2}). Ontology 120 may be effective to represent user background knowledge 103 as a set of concepts and may indicate relationships among the represented concepts. For example, if user 102 is a student of an electrical engineering program, ontology 120 may be effective to indicate a relationship among the concepts “electrical engineering”, “student”, and/or “education”.

Processor 104 may identify content data 140 associated with at least a portion of document 142 as will be described in more detail below. Processor 104 may map content data 140 to ontology 120 (depicted as operation {3}) to generate difference data 160. Mapping of content data 140 to ontology 120 may include comparing content data 140 with ontology 120. Difference data 160, which may be effective to reflect a difference between content data 140 and ontology 120, may be generated by processor 104 based on the comparison. In some examples, difference data 160 may indicate an inclusion of a particular concept in content data 140 and may indicate an exclusion of the particular concept in ontology 120. The inclusion of the particular concept in content data 140 and the exclusion of the particular concept in ontology 120 may indicate that the particular concept may be unknown to user 102. In some examples, difference data 160 may indicate a difference relating to a proficiency of a particular concept. For example, ontology 120 may indicate that user 102 has a low proficiency of a particular concept. Content data 140 may include content which require user 102 to have a high proficiency of the particular concept. Difference data 160 may indicate the difference in proficiency, which may indicate that user 102 may not be familiar with the particular concept. Difference data 160 may be represented as a table or graph. Processor 104 may be further configured to store difference data 160 in memory 106.

Processor 104 may be configured to obtain interaction data 154, while user 102 performs interaction 101. For example, an eye tracking device may be deployed in system 100. Processor 104 may control the eye tracking device in order to obtain interaction data 154 such as data relating to location, movement, and/or idle time, of an eye of user 102. Processor 104 may be configured to use interaction data to generate activity data 162 (depicted as operation {4}). Activity data 162 may be represented as a table or graph. Activity data 162 may be effective to indicate a progress of interaction 101 such as which portions of document 142 may be read by user 102. In some examples, processor 104 may obtain interaction data 154 from devices such as a computer mouse, a keyboard, a microphone, etc. Processor 104 may be further configured to store activity data 162 in memory 106.

In response to generation of activity data 162, processor 104 may compare activity data 162 with difference data 160 to determine a deviation 170 (depicted by operation {5}). Deviation 170 may be associated with interaction 101 and may be effective to indicate a difference between activity data 162 and difference data 160. Processor 104 may be configured to evaluate interaction 101 with use of deviation 170. In some examples, processor 104 may compare deviation 170 with a threshold and in response, may generate a score. Processor 104 may be further configured to generate an alert based on the score. The alert may be a pop-up message on display 108, or sound alert, to notify user 102 regarding deviation 170 associated with interaction 101.

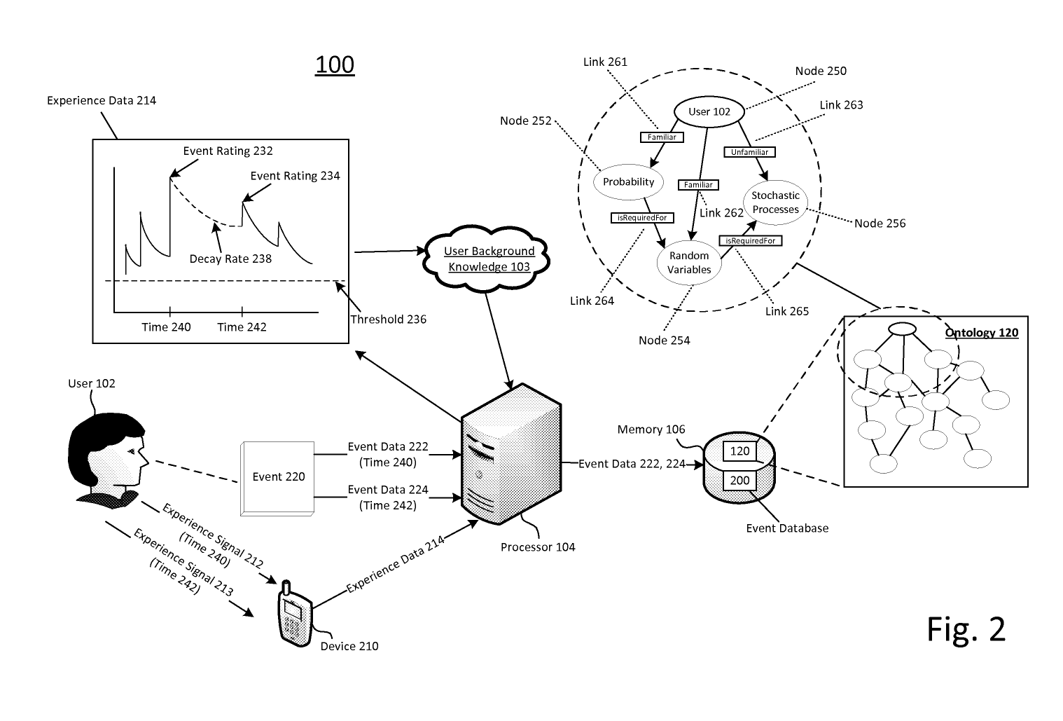

FIG. 2 illustrates example system 100 of FIG. 1 with additional detail relating to generation of the ontology, arranged in accordance with at least some embodiments described herein. FIG. 2 is substantially similar to system 100 of FIG. 1, with additional details. Those components in FIG. 2 that are labeled identically to components of FIG. 1 will not be described again for the purposes of clarity.

Processor 104 may generate ontology 120 based on events, such as an event 220, experienced by user 102. Processor 104 may receive event data 222, 224 associated with event 220. Event data 222, 224 may include words from user 102, a video displayed to user 102, a search history of user 102, and/or multimedia recorded through a device such as a wearable device or an augmented reality device. In one example, processor 104 may be configured to detect experience signal 212, such as physiological signals of user 102, and may be configured to convert experience signal 212 into experience data 214. In another example, processor 104 may receive experience data 214 from a device 210, which may be a device configured to detect experience signal 212 from user 102. Device 210, which may be for example, a heart or endorphin monitor, may be configured to convert experience signal 212 into experience data 214. Experience data 214 may be effective to indicate event ratings, such as event rating 232 or event rating 234, associated with event 220 at different times such as times 240, 242. Event ratings 232, 234 may reflect a quality of experience of user 102 associated with event 220. Processor 104 may compare event ratings 232, 234 with a threshold 236 and when an event rating is above the threshold, may identify a concept associated with event 220. Threshold 236 may be a value of a quality of experience which may be defined by user 102 or may be defined based on a history of experience data 214. Processor 104 may update user background knowledge 103 based on the identified concept and/or event ratings 232, 234. Processor 104 may further update ontology 120 based on user background knowledge 103.

In an example, user 102 may attend a class relating to stochastic processes during time 240 and time 242. In one example, user 102 may provide an input to processor 104 to indicate a start of event 220 (attendance of the class) at time 240. In another example, processor 104 may analyze experience data 214 and may detect a change in experience data 214 at time 240 where the change is above a threshold. In response to the change in experience data 214, processor 104 may determine that event 220 starts at time 240. During event 220, processor 104 may receive event data 222 at time 240 and may receive event data 224 at time 242. For example, at time 240, an instructor of the class may be giving a lecture on “probability”. Processor 104 may record the lecture at time 240, such as by using a microphone, and may store the recording at time 240 (event data 222) in an event database 200 in memory 106. At time 242, the instructor may be giving a lecture on “random variables”. Processor 104 may record the lecture at time 242 and may store the recording at time 242 (event data 224) in event database 200 in memory 106.

In the example, device 210 may be a device configured to detect a stress level of user 102. For example, experience signal 212 at time 240 may indicate a first stress level of user 102 and experience signal 213 at time 242 may indicate a second stress level of user 102. Device 210, or in some examples processor 104, may convert the first stress level into event rating 232 and may convert the second stress level into event rating 234. Device 210, or processor 104, may generate experience data 214 with use of event ratings 232, 234. Experience data 214 may be effective to indicate the stress level of user 102 at different times such as times 240, 242.

Processor 104 may analyze experience data 214 while user 102 experiences event 220. Processor 104 may compare each event rating in experience data 214 with threshold 236 and based on the comparison, may identify concepts associated with event 220. For example, processor 104 may compare event rating 232 with threshold 236. Event rating 232 may indicate the first stress level of user 102 (experience signal 212) at time 240. In response to event rating 232 being greater than threshold 236, processor 104 may search for event data associated with time 240 in event database 200. Processor 104 may determine that event data 222 was received at time 240 based on the search. Processor 104 may identify at least a concept associated with event data 222, such as the concept of “probability”. Processor 104 may associate the concept of “probability” with event rating 232. In some examples, the first stress level indicated by event rating 232 may indicate whether user 102 is stressful while learning about the concept of “probability”. A high stress level may indicate that user 102 has a low proficiency with the concept of “probability” and a low stress level may indicate that user 102 has a high proficiency with the concept of “probability”, or is learning about the concept of “probability” with a low stress level.

Similarly, processor 104 may compare event rating 234 with threshold 236. Event rating 234 may indicate the second stress level (experience signal 214) of user 102 at time 242. In response to event rating 234 being greater than threshold 236, processor 104 may search for event data associated with time 242 in event database 200. Processor 104 may determine that event data 224 was received at time 242 based on the search. Processor 104 may identify at least a concept associated with event data 224, such as the concept of “random variables”. Processor 104 may associate the concept of “random variables” with event rating 232. In some examples, the second stress level indicated by event rating 234 may indicate whether user 102 is stressful while learning about the concept of “random variables”. A high stress level may indicate that user 102 has a low proficiency with the concept of “random variables” and a low stress level may indicate that user 102 has a high proficiency with the concept of “random variables”, or is learning about the concept of “random variables” with low stress level.

In response to identification of the concepts “probability” and “random variables”, processor 104 may update user background knowledge 103 with the identified concepts and associated proficiency. If user background knowledge 103 does not include the identified concepts, processor 104 may add the identified concepts and associated proficiency in user background knowledge 103. If user background knowledge 103 includes the identified concepts, processor 104 may update the proficiency of the identified concepts in user background knowledge 103. Processor 104 may further generate and/or update ontology 120 with use of user background knowledge 103. For example, at a time prior to time 240, ontology 120 may indicate that user 102 has a low proficiency with the concept of “random variables”. After processor 104 updates user background knowledge 103, processor 104 may update ontology 120 to change the proficiency level of user 102 regarding the concept of “random variables” (e.g. change from unfamiliar to familiar).

In the example, a representation of ontology 120, such as a graph, may include at least one node, where each node may be effective to represent an entity or a concept. For example, a node 250 in ontology 120 may represent an entity of “User 102”, which may be effective to indicate that ontology 120 is associated with user 102. A node 252 in ontology 120 may represent a concept of “Probability”. A node 254 in ontology 120 may represent a concept of “Random Variables”. A node 256 in ontology 120 may represent a concept of “Stochastic Processes”.

The representation of ontology 120 may further include at least a link, where each link may be effective to connect a pair of nodes and may be effective to indicate a relationship between the pair of connected nodes, such as a dependency. A link 261 in ontology 120 may connect node 250 and node 252, and may be effective to indicate a proficiency of user 102 with the concept “Probability”. The proficiency indicated by link 261 may indicate that user 102 is familiar with the concept of “Probability”. A link 262 in ontology 120 may connect node 250 and node 254, and may be effective to indicate a proficiency of user 102 with the concept “Random Variables”. The proficiency indicated by link 262 may indicate that user 102 is familiar with the concept of “Random Variables”. A link 263 in ontology 120 may connect node 250 and node 256, and may be effective to indicate a proficiency of user 102 with the concept “Stochastic Processes”. The proficiency indicated by link 263 may indicate that user 102 is unfamiliar with the concept of “Stochastic Processes”. A link 264 in ontology 120 may connect node 252 and node 254, and may be effective to indicate a dependency between the concepts “Probability” and “Random Variables”. The dependency indicated by link 264 may indicate that the knowledge of “Probability” is required to learn the concept of “Random Variables”. A link 265 in ontology 120 may connect node 254 and node 256, and may be effective to indicate a dependency between the concepts “Random Variables” and “Stochastic Processes”. The dependency indicated by link 265 may indicate that the knowledge of “Random Variables” is required to learn the concept of “Stochastic Processes”.

In some examples, event ratings 232, 234 may be effective to indicate a quality of experience of event 220 being experienced by user 102. For example, device 210 may be a device configured to monitor an endorphin level (experience signal 212) of user 102, where the endorphin level may be effective to indicate whether user 102 is feeling happiness. Device 210 may convert the detected endorphin level of user 102 into experience data 214. Processor 104 may determine event ratings 232, 234, which may be effective to indicate a happiness level of user 102 based on the endorphin level detected by device 210. In some examples, event ratings 232, 234 may be effective to indicate a preference of user 102. For example, while user 102 is experiencing event 220, event ratings 232, 234 may be effective to indicate whether user 102 is fond of event 220, or whether event 220 is associated with a favorite activity and/or concept of user 102. In some examples, device 210 may be a device configured to detect health signals from user 102. For example, experience signals 212, 213 may be associated with a blood pressure, heartbeat rate, brain waves, speech tone, facial expression, etc., of user 102.

In another example, the instructor may be giving a lecture on “probability” at time 240 and time 242. Event data 222 received at time 240 may be a recording of the lecture. Event data 224 received at time 242 may be a statement such as “I understand it now” stated by user 102. Processor 104 may associate the concept of “probability” with event data 222, 224. At time 240, processor 104 may determine that user 102 has a low proficiency with the concept of “probability” based on event rating 232 and may update ontology 120 accordingly. At time 242, processor 104 may determine that user 102 has a high proficiency with the concept of “probability” based on event data 224 (the statement stated by user 102) and may update ontology 120 to reflect that user 102 has a high proficiency with the concept of “probability”.

In some examples, experience data 214 may be associated with a concept and may be updated based on prior event rating and time, such as a time difference between times 240, 242. Experience data 214 may decay over time at a decay rate of 238, which may be based on a setting provided by user 102 or may be based on predefined decay models used in psychological observations. Decay rate 238 may reflect a rate in which user 102 forgets or loses interest in knowledge regarding a particular concept. For example, as indicated by experience data 214, experience data 214 may decay at decay rate 238 starting from event rating 232 at time 240. At time 242, due to the input of experience signal 213, experience data 214 may be updated to event rating 234 at time 242, such as by adding at least a portion of event rating 234 to a decayed point at time 242. Experience data 214 at time 242 may reflect the value of event rating 234 plus the value of event rating 232 times decay rate 238. Experience data 214 may continue to decay at decay rate 238 starting from event rating 234 until a new experience signal is detected by device 210.

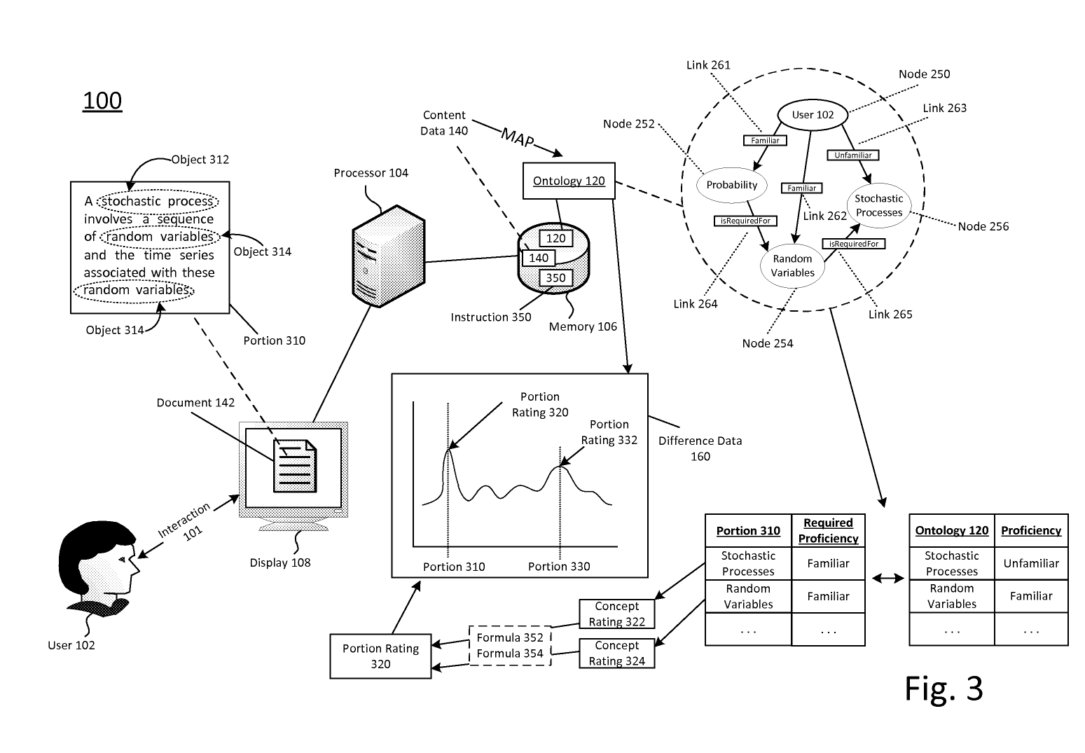

FIG. 3 illustrates example system 100 of FIG. 1 with additional detail relating to mapping content data of a document to the ontology, arranged in accordance with at least some embodiments described herein. FIG. 3 is substantially similar to system 100 of FIG. 1, with additional details. Those components in FIG. 3 that are labeled identically to components of FIG. 1 will not be described again for the purposes of clarity.

Processor 104 may identify content data 140 which may be associated with a portion 310 of document 142. Portion 310 may be a sentence in document 142, a page of document 142, etc. Portion 310 may include one or more objects, such as an object 312 and an object 314, each of which may be associated with at least a word. In the example, object 312 may be associated with the words “stochastic process” and object 314 may be associated with the words “random variables”. Processor 104 may map the content data 140 to ontology 120 to generate difference data 130 as will be described in more detail below.

In an example to map content data 140 to ontology 120, processor 104 may first identify concepts indicated by objects in portion 310 of document 142. For example, processor 104 may identify the concept of “stochastic processes” based on object 312 in portion 310 of document 142. Processor 104 may identify the concept of “random variables” based on object 314 in portion 310 of document 142. After identification of concepts indicated by objects in portion 310, processor 104 may identify proficiencies of the identified concepts using ontology 120. In some examples, if a concept identified from portion 310 is absent in ontology 120, processor 104 may determine that user 102 has a low proficiency with the identified concept. In the example, processor 104 may determine that user 102 has a low proficiency with the concept of “stochastic processes” and has a high proficiency with the concept of “random variables”.

Based on the determination of the proficiencies, processor 104 may determine concept ratings that may be associated a variance between portion 310 and ontology 120. An example variance may be a variance in proficiency levels associated with concepts in portion 310 and/or ontology 120. In the example, processor 104 may determine a concept rating 322 associated with the concept of “stochastic processes” and may determine a concept rating 324 associated with the concept of “random variables”. In the example, concept rating 322 may be greater (higher variance with respect to ontology 120) than concept rating 324 due to user 102 having a low proficiency with the concept of “stochastic processes” and having a high proficiency with the concept of “random variables”. Processor 104 may further determine a portion rating 320, which may be associated with portion 310 of document 142, with use of the determined concept ratings 322, 324. In some examples, processor 104 may sum concept ratings 322, 324 to determine portion rating 320. In some examples, processor 104 may combine concept ratings 322, 324 based on a frequency of the concepts in portion 310 or importance values associated with the concepts in portion 310. In an example, a higher portion rating may indicate that user 102 may have relatively less proficiency of the concepts in the particular portion.

In an example to determine portion rating 320, processor 104 may execute an instruction 350 stored in memory 106. Instruction 350 may be an instruction to execute a formula 352 to determine a similarity value of portion 310 based on concept ratings 322, 324, and a formula 354 to determine portion rating 320 based on the similarity value of portion 310. An example of formula 352 which may be executed by processor 104 to determine the similarity value of portion 310 may be:

M(s,n)=(1/|s|)×(sim(c₁^{s},c₁ⁿ)+sim(c₂^{s},c₂ⁿ)+ . . . +sim(cₖ^{s},cₖⁿ))

where M(s,n) relates to the similarity value of a portion s when compared to nodes n in ontology 120,

|s| is the total number of concepts in portion s, and

sim(c₁^{s},c₁ⁿ) relates to the variance in proficiency of a concept c₁ in portion s and in ontology 120, where a value of sim(c₁^{s},c₁ⁿ) may be between 0 to 1, and where a greater value of sim(c₁^{s},c₁ⁿ) may indicate a smaller variance in proficiency (or higher similarity).

In an example execution of formula 352, s may be portion 310, concept c₁ may be the concept of “stochastic processes” and concept c₂ may be the concept of “random variables”. A value of |s| may be “2” since there are two distinct concepts identified from portion 310. A value of sim(c₁^{s},c₁ⁿ) may be 0.3 due to an indication of a low proficiency of concept c₁ in ontology 120. A value of sim(c₂^{s},c₂″) may be 0.9 due to an indication of a high proficiency of concept c₁ in ontology 120. Processor 104 may execute formula 352 to determine that a value of M(s,n) may be 0.6.

An example of formula 352 which may be executed by processor 104 to determine portion rating 320 based on the similarity value of portion 310 (M(s,n)) may be:

Iₛ=β+(λ/(M(s,n)+ε))

where Iₛ may be portion rating 320 which may relate to an importance value relating to portion s,

β may be a baseline value associated with difference data 160,

λ,ε may be values relating to behaviors of user 102 and/or interaction 101, and

M(s,n) is the result from execution of formula 352.

Continuing the example, M(s,n) may be 0.6, coefficients β, λ, and ε may be 0.5, 0.3, 0.4, respectively. Processor 104 may execute formula 354 to determine that a value of Iₛ may be 0.8. Processor 104 may assign the value of 0.8 to portion rating 320. Processor 104 may continue to determine similarity values and importance values of other portions, such as portion 330, of document 142 in order to determine portion ratings such as portion rating 332.

Processor 104 may generate difference data 160 with use of portion rating 320. Difference data 160 may include portion ratings of other portions of document 142 that may be different from portion 310. For example, difference data 160 may also include portion rating 332 of a portion 330 of document 142. Portion ratings 320, 332 may be effective to indicate user proficiencies of portions 310, 330 to user 102, respectively. Processor 104 may be further configured to modify and/or update difference data 160 in response to changes in ontology 120.

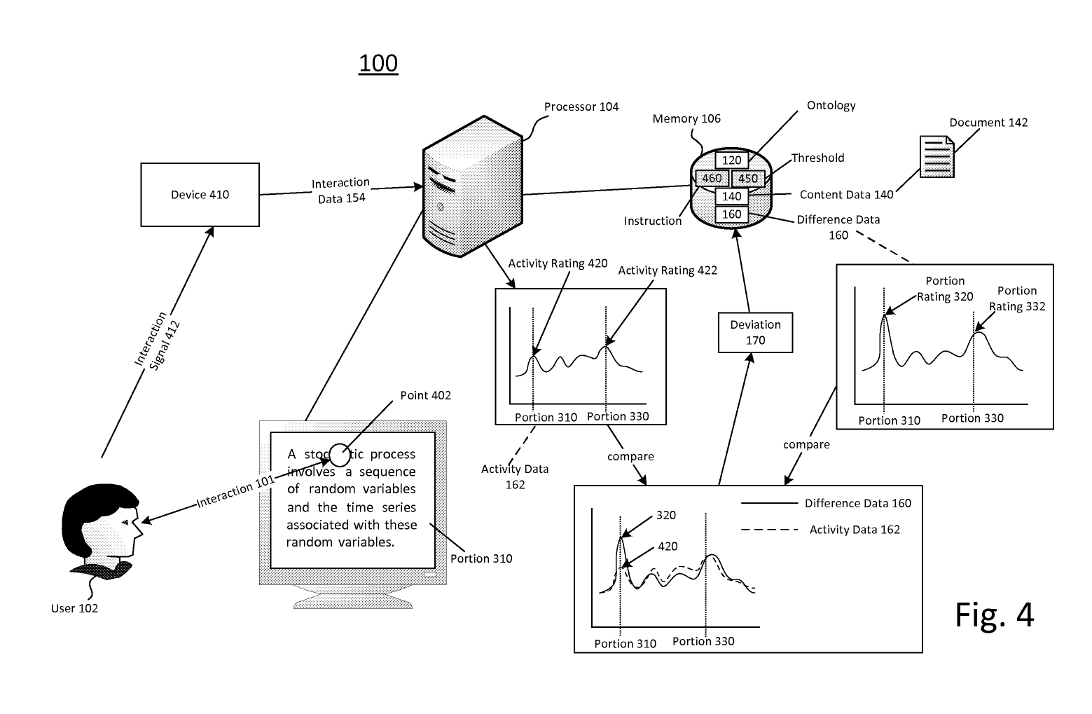

FIG. 4 illustrates example system 100 of FIG. 1 with additional detail relating to evaluation of an interaction with a document, arranged in accordance with at least some embodiments described herein. FIG. 4 is substantially similar to system 100 of FIG. 1, with additional details. Those components in FIG. 4 that are labeled identically to components of FIG. 1 will not be described again for the purposes of clarity.

A device 410 may be deployed in system 100 to detect interaction signal 412 from user 102 during interaction 101. Device 410 may be configured to convert interaction signal 412 into interaction data 154 and may send interaction data 154 to processor 104. Processor 104 may receive interaction data 154 and may generate activity data 162 with user of interaction data 154. After generation of activity data 162, processor 104 may compare activity data 162 with difference data 160 to determine deviation 170. Processor 104 may further evaluate interaction 101 with use of deviation 170.

In the example, device 410 may be an eye tracking device configured to detect a position and/or orientation of a feature, such as an eye, of user 102. During interaction 101, user 102 may view portion 310 of document 142 in display 108. Interaction signal 412 detected by device 410 may indicate a particular position and/or particular orientation of an eye of user 102. While user 102 is reading portion 310, user 102 may be viewing a point 402 of portion 310 on display 108. Point 402 may be a part of portion 310 which may include an indication of a concept. For example, point 402 may be a part of portion 310 which may include an indication of the concept “stochastic process”. Processor 104 may determine that user 102 may be viewing the concept of “stochastic process” based on an analysis of interaction data 154.

In response to the determination that user 102 may be viewing the concept “stochastic process”, processor 104 may determine an activity rating 420 associated with interaction 101. In some examples, activity rating 420 may be based on a duration in which user 102 views point 402. In some examples, activity rating 420 may be based on a behavior of user 102, such as a behavior of reading portion 310 out loud, detected by device 410, while user 102 views point 402. Processor 104 may further determine activity ratings of other portions of document 142, such as an activity rating 422 associated with portion 330 of document 142. Processor 104 may generate activity data 162 with use of the determined activity ratings such as activity ratings 420, 422.

In an example to determine activity rating 420, processor 104 may execute an instruction 460 stored in memory 106. Instruction 460 may be an instruction to execute a formula 462 to determine activity ratings 420, 422. An example of formula 462 which may be executed by processor 104 to determine activity ratings 420, 422 may be:

Rₛ=(α×(f×t×e×v)/Rₘₐₓ)+β

where Rₛ may be activity rating of a portion s,

β may be a baseline value associated with difference data 160 as indicated by formula 352 above,

α may be a value relating to interaction 101, such as a reading speed,

f may be a value relating to a frequency such as a number of times user 102 reads portion s during interaction 101,

t may be a value relating to a duration of portion s being read by user 102 during interaction 101,

e may be a value relating to editing of portion s by user 102 during interaction 101,

v may be a value relating to a audio signals associated with user 102 reading out loud during interaction 101, and

Rₘₐₓ is a maximum of activity rating associated with document 142 based on historical data.

An analysis of formula 462 may show that as user 102 reads a portion, such as portion 310, of document 142 more frequently, for a longer duration, or if user 102 at least edits portion 310 or reads portion 310 out loud, activity rating 420 of portion 310 may increase. In the example, portion rating 320 of portion 310 may indicate a high importance. Therefore, user 102 may be required to generate high activity rating by reading portion 310 more frequently or for a longer duration. Processor 104 may compare difference data 160 with activity data 162. In some examples, processor 104 may be configured to compare difference data 160 with activity data 162 periodically, such as every one minute. Comparison of difference data 160 with activity data 162 may include determining, by processor 104, a difference between a corresponding portion rating and activity rating. For example, processor 104 may determine a difference between portion rating 320 and activity rating 420. Processor 104 may determine deviation 170 based on the differences between corresponding portion rating and activity rating.

Memory 106 may further store a threshold 450 that may facilitate evaluation of interaction 101. Processor 104 may compare deviation 170 with threshold 450 to evaluate interaction 101. In the example, threshold 450 may be a value of “1”. Processor 104 may compare deviation 170 of “2” with threshold 350 of “1” and may determine that deviation 170 is greater than threshold 450. In response to deviation 170 being greater than threshold 450, processor 104 may issue an alert such as a sound, or a message to be displayed on display 108, to alert user 102. In some examples, processor 104 may compare differences between each corresponding portion rating and activity rating. If the differences are not consistent throughout a particular number of portions, processor 104 may issue the alert. The alert may be an alert to prompt user 102 to reread particular portions of document 142, or spend more time on reading particular portions of document 142. In some examples, the alert may be an alert to a provider of document 142 to inform the provider that user 102 may not be performing interaction 101 properly. For example, a provider of document 142 may be an instructor of a course and user 102 may be a student of the course. Processor 104 may issue an alert to the instructor to inform the instructor that the student is not performing interaction 101 properly.

Among other possible benefits, a system in accordance with the disclosure may benefit a user who may be reading a contract. The system may evaluate whether the user read important parts of the contract, which in response, may help the user avoid neglecting the important parts of the contract. The system may also evaluate whether a user read a document carefully. The system may also benefit students reading studying materials. The system may monitor whether a student is studying the proper portions, or unfamiliar concepts, in study materials such as an electronic book. The system may also benefit students by customizing study materials based on the background knowledge of the student. The system may also benefit instructors of a class by allowing the instructor to monitor study habits of students.

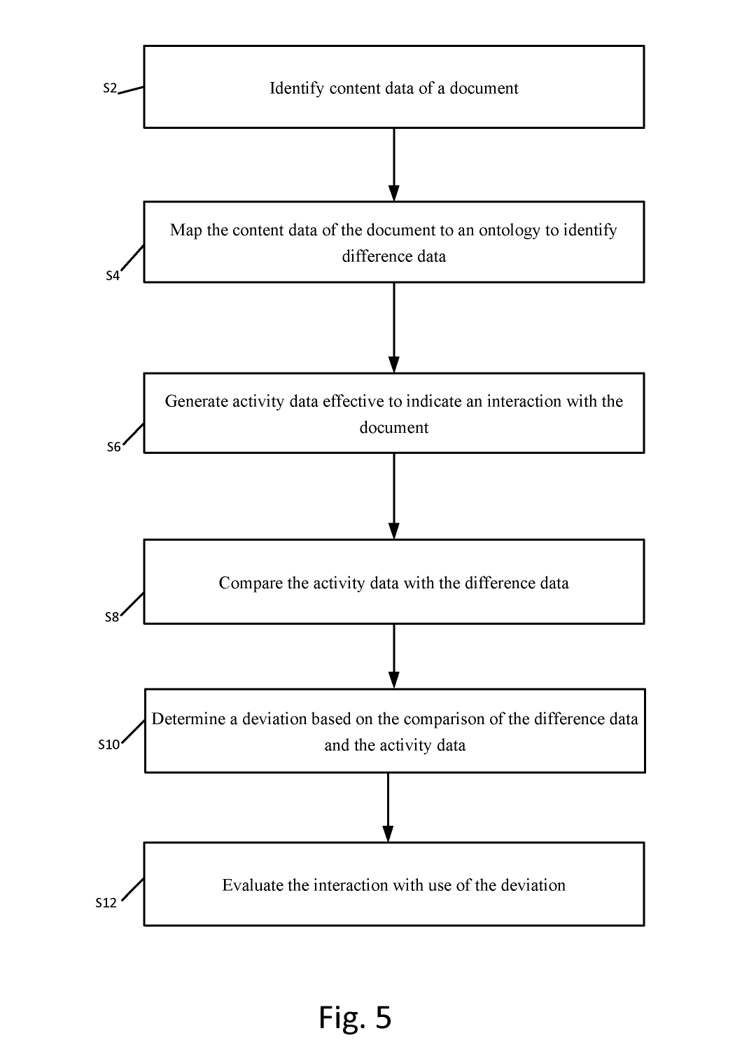

FIG. 5 illustrates a flow diagram for an example process for implementing a document interaction evaluator based on an ontology, arranged in accordance with at least some embodiments presented herein. The process in FIG. 5 could be implemented using, for example, system 100 discussed above. An example process may include one or more operations, actions, or functions as illustrated by one or more of blocks S2, S4, S6, S8, S10, and/or S12. Although illustrated as discrete blocks, various blocks may be divided into additional blocks, combined into fewer blocks, or eliminated, depending on the desired implementation.

Processing may begin at block S2, “Identify content data of a document”. At block S2, a processor may identify content data of a document. The processor may be configured to receive event data associated with an event experienced by a user. The processor may be further configured to identify a concept associated with the event data. The processor may be further configured to generate an ontology using the concept. The ontology may be associated with knowledge of the user.

Processing may continue from block S2 to block S4, “Map the content data of the document to an ontology to identify difference data”. At block S4, the processor may map the content data of the document to the ontology to identify difference data. The difference data may be effective to reflect a difference between the content data and the ontology.

Processing may continue from block S4 to block S6, “Generate activity data effective to indicate an interaction with the document”. At block S6, the processor may generate activity data. The activity data may be effective to indicate an interaction with the document. The interaction may be an interaction between the user and the document. In some examples, generation of the activity data may include obtaining interaction data, by the processor, from a device configured to detect signals associated with the interaction.

Processing may continue from block S6 to block S8, “Compare the activity data with the difference data”. At block S8, the processor may compare the activity data with the difference data.

Processing may continue from block S8 to block S10, “Determine a deviation based on the comparison of the difference data and the activity data”. At block S10, the processor may determine a deviation based on the comparison of the difference data and the activity data.

Processing may continue from block S10 to block S12, “Evaluate the interaction with use of the deviation”. At block S12, the processor may evaluate the interaction with use of the deviation. The processor may compare the deviation with a threshold and may generate a score based on the comparison. The processor may further generate an alert based on the score.

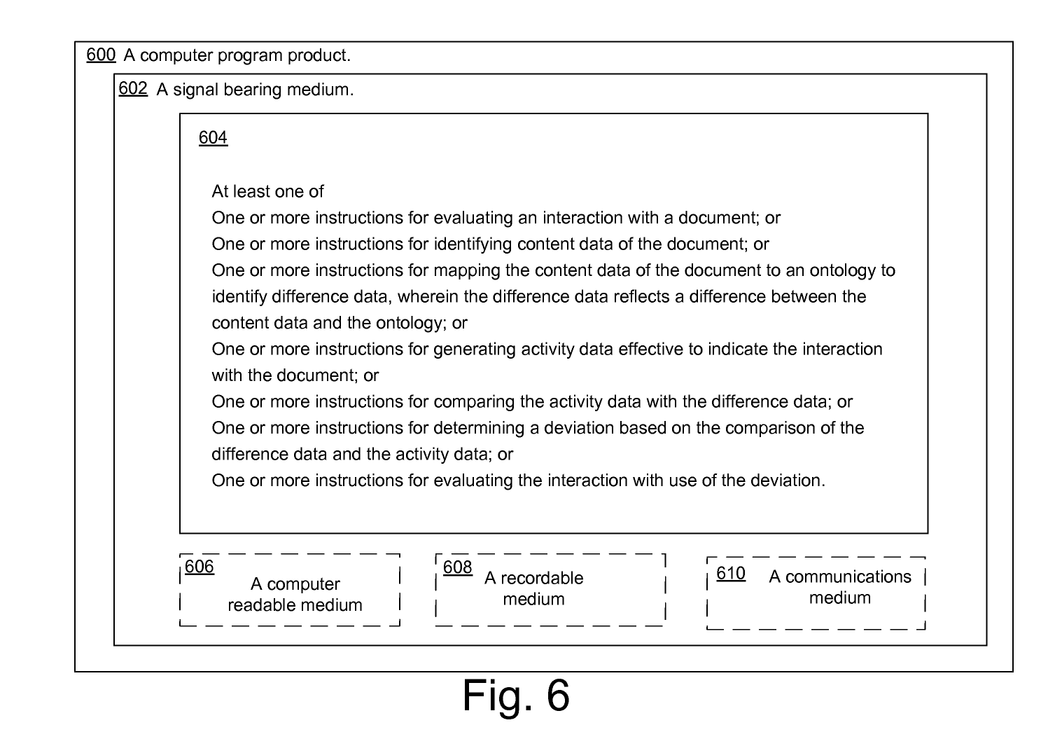

FIG. 6 illustrates an example computer program product that can be utilized to implement a document interaction evaluator based on an ontology, arranged in accordance with at least some embodiments described herein. Program product 600 may include a signal bearing medium 602. Signal bearing medium 602 may include one or more instructions 604 that, when executed by, for example, a processor, may provide the functionality described above with respect to FIGS. 1-5. Thus, for example, referring to system 100, processor 104 may undertake one or more of the blocks shown in FIG. 6 in response to instructions 604 conveyed to the system 100 by medium 602.

In some implementations, signal bearing medium 602 may encompass a computer-readable medium 606, such as, but not limited to, a hard disk drive, a Compact Disc (CD), a Digital Video Disk (DVD), a digital tape, memory, etc. In some implementations, signal bearing medium 602 may encompass a recordable medium 608, such as, but not limited to, memory, read/write (R/W) CDs, R/W DVDs, etc. In some implementations, signal bearing medium 602 may encompass a communications medium 610, such as, but not limited to, a digital and/or an analog communication medium (e.g., a fiber optic cable, a waveguide, a wired communications link, a wireless communication link, etc.). Thus, for example, program product 600 may be conveyed to one or more modules of the system 100 by an RF signal bearing medium 602, where the signal bearing medium 602 is conveyed by a wireless communications medium 610 (e.g., a wireless communications medium conforming with the IEEE 802.11 standard).

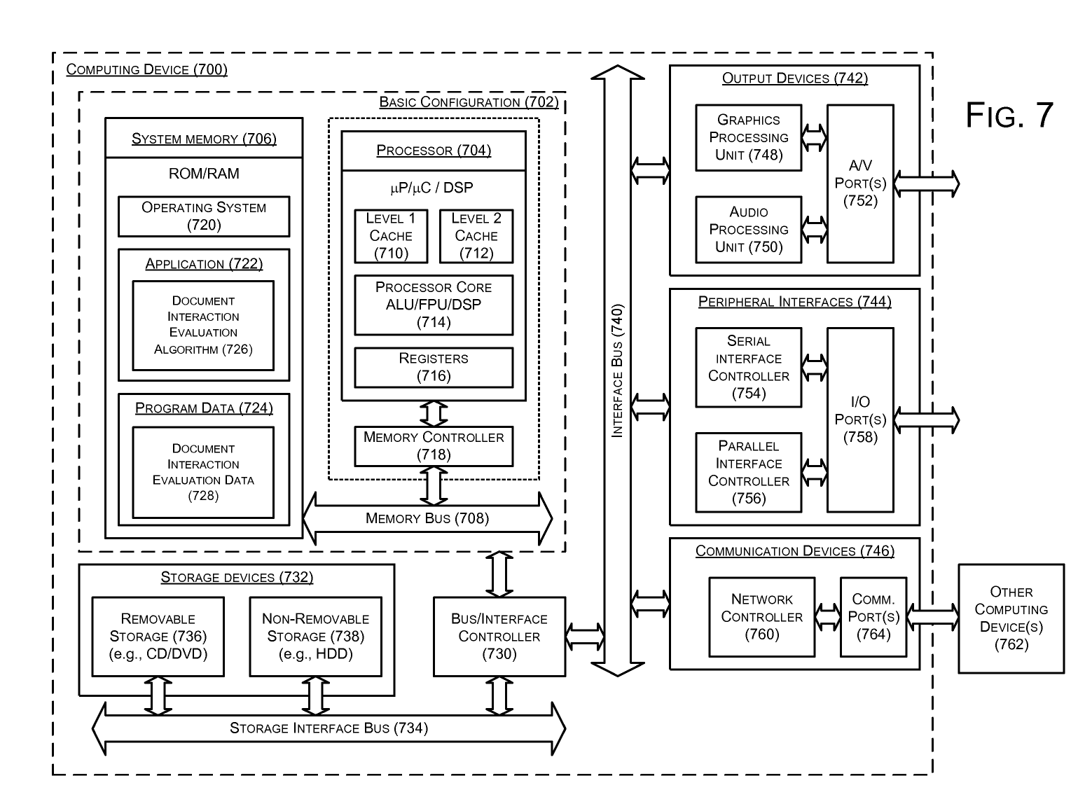

FIG. 7 is a block diagram illustrating an example computing device that is arranged to implement a document interaction evaluator based on an ontology, arranged in accordance with at least some embodiments described herein. In a very basic configuration 702, computing device 700 typically includes one or more processors 704 and a system memory 706. A memory bus 708 may be used for communicating between processor 704 and system memory 706.

Depending on the desired configuration, processor 704 may be of any type including but not limited to a microprocessor (μP), a microcontroller (μC), a digital signal processor (DSP), or any combination thereof. Processor 704 may include one more levels of caching, such as a level one cache 710 and a level two cache 712, a processor core 714, and registers 716. An example processor core 714 may include an arithmetic logic unit (ALU), a floating point unit (FPU), a digital signal processing core (DSP Core), or any combination thereof. An example memory controller 718 may also be used with processor 704, or in some implementations memory controller 718 may be an internal part of processor 704.

Depending on the desired configuration, system memory 706 may be of any type including but not limited to volatile memory (such as RAM), non-volatile memory (such as ROM, flash memory, etc.) or any combination thereof. System memory 706 may include an operating system 720, one or more applications 722, and program data 724. Application 722 may include a document interaction evaluation algorithm 726 that is arranged to perform the functions as described herein including those described with respect to system 100 of FIGS. 1-6. Program data 724 may include document interaction evaluation data 728 that may be useful for implementation of a document interaction evaluator based on an ontology as is described herein. In some embodiments, application 722 may be arranged to operate with program data 724 on operating system 720 such that implementations of evaluating interaction with document based on ontology may be provided. This described basic configuration 702 is illustrated in FIG. 7 by those components within the inner dashed line.

Computing device 700 may have additional features or functionality, and additional interfaces to facilitate communications between basic configuration 702 and any required devices and interfaces. For example, a bus/interface controller 730 may be used to facilitate communications between basic configuration 702 and one or more data storage devices 732 via a storage interface bus 734. Data storage devices 732 may be removable storage devices 736, non-removable storage devices 738, or a combination thereof. Examples of removable storage and non-removable storage devices include magnetic disk devices such as flexible disk drives and hard-disk drives (HDDs), optical disk drives such as compact disk (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer readable instructions, data structures, program modules, or other data.

System memory 706, removable storage devices 736 and non-removable storage devices 738 are examples of computer storage media. Computer storage media includes, but is not limited to, RAM, ROM, EEPROM, flash memory or other memory technology, CD-ROM, digital versatile disks (DVDs) or other optical storage, magnetic cassettes, magnetic tape, magnetic disk storage or other magnetic storage devices, or any other medium which may be used to store the desired information and which may be accessed by computing device 700. Any such computer storage media may be part of computing device 700.

Computing device 700 may also include an interface bus 740 for facilitating communication from various interface devices (e.g., output devices 742, peripheral interfaces 744, and communication devices 746) to basic configuration 702 via bus/interface controller 730. Example output devices 742 include a graphics processing unit 748 and an audio processing unit 750, which may be configured to communicate to various external devices such as a display or speakers via one or more A/V ports 752. Example peripheral interfaces 744 include a serial interface controller 754 or a parallel interface controller 756, which may be configured to communicate with external devices such as input devices (e.g., keyboard, mouse, pen, voice input device, touch input device, etc.) or other peripheral devices (e.g., printer, scanner, etc.) via one or more I/O ports 758. An example communication device 746 includes a network controller 760, which may be arranged to facilitate communications with one or more other computing devices 762 over a network communication link via one or more communication ports 764.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 700 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 700 may also be implemented as a personal computer including both laptop computer and non-laptop computer configurations.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will also be understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method to evaluate an interaction with a document, the method comprising, by a processor:
identifying content data of the document;
mapping the content data of the document to an ontology to identify difference data, wherein the difference data reflects a difference between the content data and the ontology;
generating activity data effective to indicate the interaction with the document, where the document includes the content data;
comparing the activity data with the difference data;
determining a deviation based on the comparison of the difference data and the activity data; and
evaluating the interaction with the document that includes the content data with use of the deviation.

2. The method of claim 1, wherein the ontology is associated with knowledge of a user, and the interaction is an interaction between the user and the document.

3. The method of claim 2, further comprising, prior to mapping the content data to the ontology:
receiving event data associated with an event experienced by the user;
identifying a concept associated with the event data; and
generating the ontology using the concept.

4. The method of claim 3, wherein identifying the concept associated with the event data includes receiving at least one of words from a user, video displayed to a user, a search history of the user, or multimedia recorded through an augmented reality device.

5. The method of claim 3, wherein the event data is first event data, the concept is a first concept, and the method further comprises:
receiving second event data;
identifying a second concept associated with the second event data;
updating the ontology using the second concept; and
updating the difference data in response to the update of the ontology.

6. The method of claim 1, wherein generating the activity data includes obtaining interaction data from a device configured to detect signals associated with the interaction.

7. The method of claim 6, wherein the device is an eye tracking device.

8. The method of claim 1, wherein mapping the content data to the ontology comprises:
identifying a portion of the content data, wherein the portion of the content data is associated with a concept in the document; and
determining a rating of the portion, wherein the rating is effective to indicate a variance between the portion and the ontology, and wherein the difference data is based on the rating.

9. The method of claim 1, wherein evaluating the interaction comprises:
comparing the deviation with a threshold; and
generating a score based on the comparison, wherein the evaluation is based on the score.

10. The method of claim 9, further comprising generating an alert based on the score.

11. A system configured to evaluate an interaction associated with a document, the system comprising:
a memory configured to store:
content data of the document; and
an ontology;
a processor configured to be in communication with the memory, the processor being configured to:
identify the content data of the document in the memory;
map the content data of the document to an ontology to identify difference data, wherein the difference data reflects a difference between the content data and the ontology;
store the difference data in the memory;
generate activity data effective to indicate the interaction with the document, where the document includes the content data;
store the activity data in the memory;
compare the activity data with the difference data;
determine a deviation based on the comparison of the difference data and the activity data; and
evaluate the interaction with the document that includes the content data with use of the deviation.

12. The system of claim 11, further comprising a device configured to detect signals associated with the interaction, wherein the processor is further configured to obtain interaction data from the device.

13. The system of claim 12, wherein the device is an eye tracking device.

14. The system of claim 11, wherein the ontology is associated with knowledge of a user, and the interaction is an interaction between the user and the document.

15. The system of claim 14, wherein the processor is further configured to:
receive event data associated with an event experienced by the user;
identify a concept associated with the event data;
generate the ontology using the concept; and
store the ontology in the memory.

16. The system of claim 11, wherein the processor is further configured to:
identify a portion of the content data, wherein the portion of the content data is associated with a concept in the document; and
determine a rating of the portion, wherein the rating is effective to indicate a variance between the portion and the ontology, and wherein the difference data is based on the rating.

17. The system of claim 11, wherein the processor is further configured to:
compare the deviation with a threshold; and
generate a score based on the comparison, wherein the evaluation is based on the score.

18. The system of claim 17, wherein the processor is further configured to generate an alert based on the score.

19. A method to generate an ontology associated with a user,
the method comprising, by a processor:
receiving event data associated with an event experienced by the user;
determining an event rating of the event using the event data, wherein the event rating is effective to indicate a quality of the event experienced by the user;
comparing the event rating to a threshold;
identifying a concept associated with the event based on the comparison; and
generating the ontology using the concept.

20. The method of claim 19, wherein the ontology is associated with knowledge of the user.

21. (canceled)

22. The method of claim 20, wherein the event rating is effective to indicate a physiological signal of the user.

23. The method of claim 19, wherein the event is a first event, the event data is first event data, the event rating is a first event rating, and the method further comprises:
receiving second event data associated with a second event experienced by the user;
determining a second event rating of the second event using the second event data; and
updating the first event rating with use of the second event rating.

24. The method of claim 23, wherein the first event data is received at a first instance in time, the second event data is received at a second instance in time, and updating of the first event rating is based on the first event rating and based on a time between the first and second instances in time.
